(19) United States
(12) Patent Application Publication
(10) Pub. No.: US 2009/0101184 A1
(43) Pub. Date: Apr. 23, 2009

(54) Spa filter cleaning device

(76) Inventors: Lance Frederick Wendel, Kula, HI (US); Carol Lewis Wendel, Kula, HI (US)

Correspondence Address: GALASSO & ASSOCIATES, LP, P.O. BOX 26503, AUSTIN, TX, 78755-0503, US

(21) Appl. No.: 11/975,319

(22) Filed: Oct. 18, 2007

(51) Int. Cl. B08B 3/04; B08B 3/06

(52) U.S. Cl. 134/119; 134/166 R

(57) ABSTRACT

A spa filter cartridge cleaning apparatus configured to substantially remove contaminants from a spa filter cartridge. The cleaning apparatus further includes a container that has a plurality of walls configured to define an interior volume of sufficient size to receive a spa filter cartridge therein. A cleaning cylinder is disposed within the container and functions to be mateably connected with the hollow core of a spa filter cartridge. The cleaning cylinder further includes a plurality of apertures that function to discharge cleaning liquid disposed within the cleaning cylinder. An attachment mechanism operably connects the cleaning cylinder to a water source. A pinion gear is operably connected to one end of the cleaning cylinder and functions to rotate the cleaning cylinder for increased cleaning effectiveness of the spa filter cartridge secured thereto.

### FIELD OF THE INVENTION

The present invention relates to a cleaning device, more specifically but not by way of limitation, a cleaning device that is designed to receive therein a spa or pool filter in order to substantially remove all of the particles and contaminants trapped therein so as to effectively clean the cartridge filter for reuse.

### BACKGROUND

Millions of homeowners own a pools and spas/hot-tubs, in the United States. These spas and pools are used for recreation as well as for therapeutic reasons. Regardless of the type of spa or pool, most systems have a common method of plumbing. One component of the plumbing system of a spa or pool is a filter. Commonly, the spa or pool utilizes a filter to clean the water in the pool or spa. The filter cleans the water of microscopic and large particles that dirty the water as well as can potentially clog the pump and cause significant damage. Many pools and most spas utilize a multiple layer filter that is cylindrical in shape and is manufactured of a pleated paper-like material such as dacron. The pleats function to increase the surface area which improves the performance of the filter. Regular cleaning of these filters is required for proper spa and pool filter operation.

One problem with cleaning the types of pool and spa filters is a result of the pleats. The pleats inhibit a user from effectively cleaning the spa filter as the contaminants that have been trapped in the crease of the pleat are difficult to remove. Most users will utilize a garden hose in attempt to clean the pleats which has proven to be ineffective. Additionally, as some of the contaminants are trapped in within one of the plurality of layers, attempting to clean the spa filter utilizing a water flow directed inwardly toward the center of the filter requires that the trapped contaminants be pushed completely through the filter to the hollow core so as to be removed. Not only is this method ineffective in removing most of the contaminants it is also very time consuming.

Accordingly, there is a need for a device that will facilitate the effective cleaning of a spa filter cartridge that can reduce the amount of time required to clean the filter and effectively remove most of the contaminants.

### SUMMARY OF THE INVENTION

It is the object of the present invention to provide a cleaning device that is configured to receive therein a spa or pool filter cartridge in order to facilitate effective removal of contaminants thereon.

Another object of the present invention to provide a spa or pool filter cartridge cleaning device that contains therein a sieved core member that engages with the hollow core of a conventional spa or pool filter cartridge.

A further object of the present invention is to provide a cleaning device that is configured to utilize water pressure directed outwardly from the center of the spa or pool filter to effectively remove the contaminants disposed thereon the spa or pool filter cartridge.

Another object of the present invention is to provide a spa or pool filter cleaning device that can be releasably secured to a conventional garden hose.

An additional object of the present invention is to provide a spa or pool filter cleaning device the uses centrifugal force to assist in the extrusion of the contaminants that are disposed on the spa or pool filter.

A further object of the present invention is to provide a spa or pool filter cleaning device that is relatively inexpensive and easy to use.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawing wherein:

FIG. 1 is an end view of an embodiment of the present invention; and

FIG. 2 is a sectional view taken along line 2-2 of FIG. 1.

### DETAILED DESCRIPTION

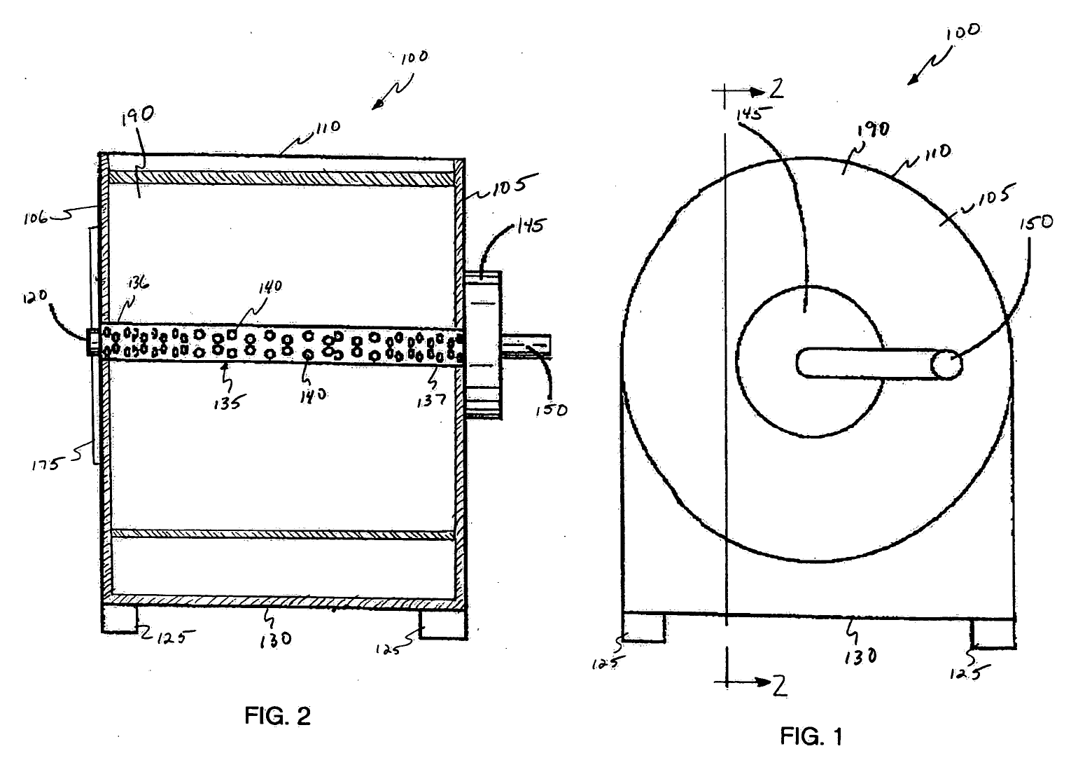

Referring now to the drawings submitted herewith wherein the various elements depicted therein are not necessarily drawn to scale and wherein like elements are identified with like reference numerals and in particular FIGS. 1 and 2, there is illustrated a preferred embodiment of a filter cleaning apparatus 100 constructed according to the principles of the present invention.

The filter cleaning apparatus 100 comprises a substantially hollow container 190 including walls 105 and 106, a bottom 130 and a top 110 and is configured to define an interior volume sufficient to receive a filter cartridge therein. The container 190 is manufactured from suitable durable materials such as but not limited to plastic. Although the container 190 is illustrated in the drawings submitted herewith as being substantially square in shape, those skilled in the art will recognize that the container 190 could be constructed in numerous different shapes. Furthermore, it should be recognized that the container 190 could be manufactured to have any number of walls configured to form an interior volume. Filter cleaning apparatus 100 includes a door 175 integrated with side walls 106 for a user to access the interior volume of the container 190.

Secured to the bottom 130 of the container 190 are leg members 125. The leg members 125 engage a suitable horizontal support structure on which the filter cleaning apparatus 100 has been placed. The leg members 125 are manufactured from a durable non-slip material in order to provide lateral stability of the filter cleaning apparatus 100 when in use. More specifically but not by way of limitation, the leg members 125 are manufactured from rubber. It is contemplated within the scope of the present invention that the bottom 130 could be manufactured in a plurality of different manners. For example, the bottom 130 could be manufactured as a solid surface thereby substantially inhibiting the liquid disposed within the filter cleaning apparatus 100 during use from propagating out of the container 190. This configuration is suited for situations such as but not limited to, the ability to retain and dispose properly of a chemical cleaning agent or for use in an area that it is not desirable to discharge liquid thereon. Additionally, the bottom 130 could have a plurality of holes or one hole facilitating the release of any liquid discharged into the container 190 during use.

A cleaning cylinder 135 is rotatably mounted within the interior volume of the filter cleaning apparatus 100. The cleaning cylinder 135 is substantially hollow and generally rod-like in shape having an internal volume for receiving a liquid therein. The cleaning cylinder 135 further includes a plurality of apertures 140. The cleaning cylinder 135 is secured generally perpendicular and intermediate side walls 105 and 106. A pinion gear 145 is operably connected to the cleaning cylinder 135 and is secured by suitable mechanical methods to the side wall 105. The pinion gear 145 is mounted externally to the side wall 105 wherein the side wall 105 is intermediate the pinion gear 145 and the cleaning cylinder 135. Those skilled in the art will recognize that the pinion gear 145 could be mounted on either the internal or external surface of the side wall 105. The cleaning cylinder 135 is of sufficient diameter such that a user can mateably secure thereon a conventional spa or pool filter cartridge having a hollow core similar in shape to the cleaning cylinder 135. Those skilled in the art will recognize that the cleaning cylinder 135 could be manufactured in numerous different shapes so as to mateably receive thereon the hollow core of a spa or pool filter cartridge.

An attachment mechanism 120 is secured by suitable chemical or mechanical methods to one end 136 of the cleaning cylinder 135. The attachment mechanism 120 is a threaded mechanical connector that functions to connect the filter cleaning apparatus 100 to a water source such as by not limited to a conventional garden hose. Water or any other suitable cleaning liquid enters the substantially hollow cleaning cylinder 135 proximate the end 136 and flows therethrough towards the end 137. As the volume of the liquid entering the cleaning cylinder 135 exceeds the internal volume of the cleaning cylinder 135, the liquid is discharged through the plurality of apertures 140 on the cleaning cylinder 135. The discharged liquid carries therewith a force that is relative to the volume of liquid entering into the cleaning cylinder 135. The liquid being discharged from the apertures 140 will propagate the adjacent filter cartridge resulting in the substantial removal of the contaminants from the filter cartridge.

Additionally, as the cleaning cylinder 135 is operably connected to the pinion gear 145, the cleaning cylinder 135 can be rotated as liquid is being forced thereinto creating a centrifugal force on the liquid disposed within the cleaning cylinder 135 and the adjacent spa filter cartridge thereby increasing the flow rate through the apertures 140 and resulting in increased cleaning effectiveness. The rotation of the cleaning cylinder 135 and the spa filter cartridge attached thereto functions to also remove excess liquid retained by the spa filter cartridge along with the contaminants. Although no particular ratio is required for the pinion gear 145, good results have been achieved utilizing a pinion gear 145 with a ratio of three-to-one thereby functioning to rotate the cleaning cylinder 135 three full rotations for every one full rotation of the pinion gear 145.

A handle 150 is operably attached to the pinion gear 145 that functions to provide a user interface to rotate the pinion gear 145. The handle 150 is secured to the pinion gear 145 by suitable and durable mechanical or chemical methods. Although the filter cleaning apparatus 100 is illustrated in the drawings submitted herewith as having a handle 150 to manually rotate the pinion gear 145 that is operably connected to the cleaning cylinder 135, it is further contemplated within the scope of the present invention that the pinion gear 145 could be operably connected to a motor to facilitate the rotation thereof.

While not illustrated in the drawings submitted herewith, it is contemplated within the scope of the present invention that the filter cleaning apparatus 100 further include a contaminant sensing device that would function to measure the amount of contaminants disposed on the spa filter cartridge when initially secured onto the cleaning cylinder 135 and further function to signal to a user subsequent to the substantial removal of the contaminants from the spa filter cartridge. Those skilled in the art should recognize that the filter cleaning apparatus 100 could function to clean numerous different items in addition to a spa or pool filter cartridge.

A description of the operation of the filter cleaning apparatus 100 is as follows. In use a user will open the door 175 secured to the side wall 106 thereby providing access to the end 136 of the cleaning cylinder 135. The user will then secure the desired object to be cleaned such as but not limited to a spa or pool filter cartridge onto the cleaning cylinder 135. Following mateably securing the spa filter cartridge to the cleaning cylinder 135 the user will close the hingedly mounted door on the side wall 106. Ensuing the closure of the door, the user will secure the attachment mechanism 120 to the threaded end of the garden hose. Following securing the water source to the container 190, the user will activate the flow of water into the filter cleaning apparatus 100. As the flow of water enters the cleaning cylinder 135 and the volume of water exceeds the internal volume of the cleaning cylinder 135, the water is discharged from the plurality of apertures 140 onto the adjacent spa filter cartridge. As the water is discharged from the apertures 140, the adjacent spa filter cartridge is substantially rinsed of any contaminants disposed thereon. Additionally, as the water is being discharged from the apertures 140 on the cleaning cylinder 135 onto the adjacent spa filter cartridge, the user can rotate the cleaning cylinder 135 that is operably engaged with the pinion gear 145 via the handle 150. Rotating the cleaning cylinder 135 creates a centrifugal force that assists in propagating the water through the fibrous spa filter cartridge and increases the cleaning efficiency and removal of the contaminants disposed thereon. Subsequent to cleaning the spa filter cartridge for the desired amount of time the user will disconnect the water source from the attachment mechanism 120 and open the door in order to retrieve the spa filter cartridge.

In the preceding detailed description, reference has been made to the accompanying drawing that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A filter cleaning apparatus comprising:
a container, said container having a plurality of walls configured to define an interior volume sufficient in size to receive a filter therein to be cleaned, said container further including a bottom and a top; and
a cleaning cylinder positioned within said container, said cleaning cylinder being substantially hollow and elongated in shape, said cleaning cylinder configured to receive thereon a filter for cleaning.

2. The filter cleaning apparatus as recited in claim 1, wherein said cleaning cylinder includes a connector configured to be operably connected to a cleaning liquid source.

3. The filter cleaning apparatus as recited in claim 2, wherein said cleaning cylinder further includes a plurality of apertures, said apertures for dispersing cleaning liquid received from the cleaning liquid source to the filter for cleaning.

4. The filter cleaning apparatus as recited in claim 3, wherein said cleaning cylinder is rotatably positioned with said container such that the filter for cleaning can be rotated when within said container.

5. The filter cleaning apparatus as recited in claim 4, wherein said connector is a garden hose connector and configured to receive thereon a garden hose.

6. The filter cleaning apparatus as recited in claim 5, and further including a door connected to said container.

7. The filter cleaning apparatus as recited in claim 6, wherein the object to be cleaned is a spa or pool filter cartridge.

8. A cleaning apparatus for cleaning a plurality of filters comprising:
a container, said container having four walls, a bottom and a top configured to define an interior volume sufficient in size to receive therein a plurality of filters, wherein one of said four walls has mounted thereto a door for accessing the interior of said container; and
a cleaning cylinder, said cleaning cylinder having a first end and a second end, said cleaning cylinder being generally rod shaped and substantially hollow for receiving liquid therein, said cleaning cylinder being secured within said container intermediate two of said four walls in a generally perpendicular manner thereto, said cleaning cylinder configured to receive thereon a filter for cleaning.

9. The cleaning apparatus as recited in claim 8, wherein said cleaning cylinder further includes a plurality of apertures, said apertures for dispersing the cleaning liquid disposed within said cleaning cylinder onto a filter releasably secured thereto for cleaning the filter.

10. The cleaning apparatus as recited in claim 9, and further including a connector secured to said cleaning cylinder, said connector being configured to releasably secure to a cleaning liquid source.

11. The apparatus as recited in claim 10, and further including a pinion gear, said pinion gear being operably connected to said cleaning cylinder, said pinion gear operable to rotate said cleaning cylinder.

12. The apparatus as recited in claim 11, and further including a handle connected to said pinion gear.

13. The apparatus as recited in claim 12, wherein the pinion gear is operable to provide a three to one rotation ratio to said cleaning cylinder.

14. The apparatus as recited in claim 13, wherein said container has mounted thereon a plurality of rubber feet for providing stability during use of said container.

15. A cleaning apparatus for cleaning a spa filter cartridge comprising:
a container, said container having four walls, a bottom and a top configured to define an interior volume sufficient in size to receive a spa filter cartridge therein, wherein one of said four walls further includes a door configured to provide access to the interior volume of said container; and
a cleaning cylinder, said cleaning cylinder having a first end and a second end, said cleaning cylinder being elongated in shape and substantially hollow to receive a cleaning liquid therein, said cleaning cylinder being disposed within said container intermediate said door and one of said four walls and generally perpendicular thereto, said cleaning cylinder further including a plurality of apertures, said apertures operable to disperse the cleaning liquid disposed within said cleaning cylinder onto a spa filter cartridge releasably secured thereto for substantially removing contaminants thereon.

16. The cleaning apparatus as recited in claim 15, wherein said first end of said cleaning cylinder is configured to be releasably secured to a garden hose operable to control water flow to said cleaning cylinder.

17. The cleaning apparatus as recited in claim 16, and further including a pinion gear, said pinion gear being operably connected to said cleaning cylinder, said pinion gear operable to rotate said cleaning cylinder, said pinion gear mounted proximate said second end of said cleaning cylinder, said pinion gear being mounted externally to one of said four walls of said container.

18. The cleaning apparatus as recited in claim 17, wherein said attachment mechanism is configured to releasably secure to a garden hose for allowing water to be utilized as the cleaning liquid.

19. The cleaning apparatus as recited in claim 18, wherein the pinion gear is operable to provide a three to one rotation ratio to said cleaning cylinder.

20. The cleaning apparatus as recited in claim 19, wherein said container is two feet in height by one foot in width and one foot in length.
